(19) United States
(12) Patent Application Publication
(10) Pub. No.: US 2020/0307501 A1
(43) Pub. Date: Oct. 1, 2020

(54) RECOIL VALVE FOR IGNITION CAPSULE FOR OCCUPANT RESTRAINT SYSTEMS

(71) Applicant: EMS-PATVAG S.V.O., Brankovice (CZ)

(72) Inventors: Günter DÜRSCHINGER, Fürth (DE); Elisabeth DÜRSCHINGER, Fürth (DE)

(73) Assignee: EMS-PATVAG S.V.O., Brankovice (CZ)

(21) Appl. No.: 16/089,768

(22) PCT Filed: Mar. 24, 2017
(86) PCT No.: PCT/IB2017/000427

§ 371 Date: Sep. 28, 2018

(30) Foreign Application Priority Data
Mar. 31, 2016 (DE) 10 2016 004 378.4

(51) Int. Cl. B60R 21/264; F16K 7/12

(52) U.S. Cl. CPC B60R 21/264; B60R 2021/26029; F16K 7/12

(57) ABSTRACT

The invention relates to a recoil valve for the trigger capsule for the gas generator of a passenger restraint system in an automotive vehicle, in particular for the gas generator of an inflatable impact protection cushion (airbag), measures being taken in order to avoid a relative movement of the glass insulation or of the contact pin in the trigger capsule due to the released quantity of gas or during the ignition process.

The invention relates to a recoil valve for a trigger capsule for the gas generator of a passenger restraint system in an automotive vehicle.

Inflatable impact protection cushions (airbag) belong to the most frequently used passenger restraint systems. The restraint systems require a gas generator, the propellant of which, in the case of a automotive vehicle collision, is made to explode by a trigger capsule. The consequently released quantity of gas inflates the airbag.

Trigger capsules for airbag gas generators are known according to the state of the art (Patent 10 2014016 923).

Attempts to achieve ever shorter trigger times of the airbags in the case of an accident have led to the development of more highly explosive ignition means with increased explosive power.

In the patent application reference no. 10 2015 014 124.4, a trigger capsule is described, a booster charge being provided alternatively in addition, as a result of which the explosive power for releasing the quantity of gas in the gas generator is also substantially increased.

The object underlying the recoil valve according to the invention is to avoid a relative movement of the glass insulation of the contact pin in the trigger capsule due to the released quantity of gas or during the ignition process.

In order to achieve the object, the incorporation of a recoil valve in the trigger capsule with or without a booster charge is proposed. The invention is explained in more detail subsequently with reference to embodiments:

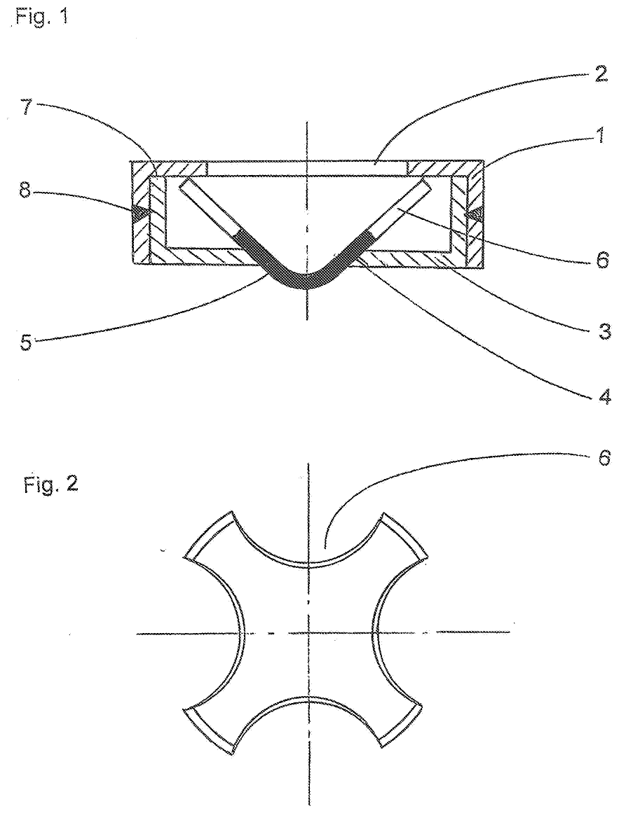

FIG. 1 shows schematically a section through the recoil valve according to the invention. The recoil valve has a pot-shaped upper part 1 with a boring 2, a diaphragm spring 5 with a conical valve seat 4 and at least 3 recesses 6 on the circumference and a pot-shaped lower part 3 with a conical valve seat 4, the lower part 3 equipped with the diaphragm spring 5 being securely connected to the upper part 1 by a circumferential weld seam 8, after insertion into the upper part 1 against limit stop 7.

FIG. 2 shows the diaphragm spring with 4 recesses on the circumference.

1-4. (canceled)

5. A recoil valve for a trigger capsule of a gas generator in a passenger restraint system of an automotive vehicle, the recoil valve having a pot-shaped upper part with a boring, a diaphragm spring with a conical valve seat and at least 3 recesses on the circumference and a pot-shaped lower part with a conical valve seat, the lower part equipped with the diaphragm spring being securely connected to the upper part by a circumferential weld seam, after insertion into the upper part against limit stop.

6. The recoil valve according to claim 5, wherein a weld seam is omitted and/or a protruding edge of the upper part is flanged.

7. The recoil valve according to claim 5, wherein the recoil valve is incorporated in the trigger capsule with or without a booster charge.

8. The recoil valve according to claim 5, wherein the diaphragm spring is incorporated functionally in the housing of a booster charge.
